(19) United States
(12) Patent Application Publication
(10) Pub. No.: US 2007/0218233 A1
(43) Pub. Date: Sep. 20, 2007

(54) FUEL IMPERMEABLE, FUEL RESISTANT HOSE HAVING IMPROVED HIGH TEMPERATURE RESISTANT CHARACTERISTICS

(76) Inventors: Jeremy Duke, Henderson County, TN (US); Kenneth Scott Jackson, Lexington, TN (US); Jerry Shifman, Wildersville, TN (US)

Correspondence Address: DAYCO PRODUCTS, LLC, 1 PRESTIGE PLACE, MIAMISBURG, OH, 45342, US

(21) Appl. No.: 11/757,659

(22) Filed: Jun. 4, 2007

Related U.S. Application Data
(63) Continuation-in-part of application No. 10/823,893, filed on Apr. 13, 2004, now Pat. No. 7,228,877.
Application No. 10/823,893 is a continuation-in-part of application No. 10/071,634, filed on Feb. 7, 2002, now abandoned.
Application No. 10/071,634 is a division of application No. 09/754,674, filed on Jan. 4, 2001, now Pat. No. 6,365,250.
Application No. 09/754,674 is a division of application No. 09/083,294, filed on May 22, 1998, now Pat. No. 6,203,873.

(51) Int. Cl. F16L 11/04

(52) U.S. Cl. 428/36.91

(57) ABSTRACT

A fuel impermeable, fuel resistant hose having improved high temperature resistant characteristics sufficient to provide extended service life of the hose in a harsh thermal environment comprising at least one fluoropolymer tubular structure, and a backing layer surrounding the at least one fluoropolymer tubular structure wherein the backing layer comprises at least one high temperature resistant elastomer selected from the group consisting of ethylene-acrylate elastomer, ethyl-vinyl acetate copolymer, acrylic rubber, and blends thereof, said backing layer exhibiting superior high temperature resistance compared to conventional backing layers. The hose optionally contains a reinforcement member around the at least one fluoropolymer tubular structure, and a high temperature-resistant cover over the reinforcement member.

This application is a continuation-in-part of Ser. No. 10/823,893, filed Apr. 13, 2004, which is a continuation-in-part of Ser. No. 10/071,634, filed Feb. 7, 2002, now abandoned, which is a division of Ser. No. 09/754,674, filed Jan. 4, 2001, now U.S. Pat. No. 6,365,250, which is a division of Ser. No. 09/083,294, filed May 22, 1998, now U.S. Pat. No. 6,203,873.

### BACKGROUND OF THE INVENTION

The present invention relates to the field of hoses, particularly to the field of automotive fuel hoses, and more particularly to multilayer automotive fuel-impermeable hoses having improved resistance to high temperature compared to conventional hoses.

Polymeric hoses are known and used in a variety of applications such as automotive and industrial hoses, refrigerator hoses, garden hoses, propane gas hoses, etc. Often hoses are required to have certain characteristics and properties that allow them to function satisfactorily in specialized applications. For example, industrial hydraulic and compressed air hoses are required to exhibit high strength and burst resistance; flexibility is a highly desirable characteristic of hoses used in applications where space configurations are limited; chemical and hydrocarbon-resistance is needed in automotive applications such as torque converter hoses, air conditioner hoses, power steering hoses, brake fluid hoses, heater hoses and engine coolant hoses; and impermeability of hydrocarbon fuel is particularly required in the automotive fuel transport hoses.

Various types of tubing construction have been employed to meet the needs of the various applications of hoses. However, choosing the right combination of materials used in the construction of such hoses, particularly, fuel hoses, is becoming more difficult due to the evolution of highly sophisticated technology and the ever increasing environmental regulations which severely limit the amount of fuel emissions that can permeate from the fuel system of a motor vehicle into the atmosphere. Currently, the various automotive fuel hoses are constructed of multilayer tubular structures. Typically, such multilayer tubular structures are formed of an elastomeric fuel resistant material, a thermoplastic fuel impermeable material, a backing layer, a reinforcement layer and a durable outer cover layer. More particularly, the multilayer automotive fuel hose is formed from a fluoropolymer (FKM) inner layer, a tetrafluoroethylene-hexafluoropropylene-vinylidene fluoride terpolymer (THV) barrier layer, a nitrile or epichlorohydrin (ECO) backing layer, a reinforcement layer, and a protective cover layer.

Commonly assigned U.S. Pat. Nos. 6,203,873 and 6,365,250, the contents of which are incorporated herein by reference thereto, teach a hose constructed of a barrier layer comprising a blend of a first fluoroelastomer interpolymer wherein the first fluorointerpolymer is a copolymer or terpolymer formed by the copolymerization of two or more monomers selected from the group consisting of hexafluoropropylene, vinylidene fluoride and tetrafluoroethylene, and a second fluorointerpolymer wherein the second fluorointerpolymer is a terpolymer formed by the copolymerization of hexafluoropropylene, vinylidene fluoride and tetrafluoroethylene, wherein the first fluorointerpolymer exhibits elastomeric characteristics and the second fluorointerpolymer exhibits thermoplastic characteristics. A first elastomeric layer is a conductive acrylonitrile-butadiene rubber, conductive ethylene-acrylate or conductive fluoroelastomer. A second elastomeric layer is primarily a material having adhesive properties such as a non-conductive acrylonitrile-butadiene rubber, epichlorohydrin rubber or ethylene-acrylate rubber for adhering the barrier layer to the cover. Preferably, the second elastomer is a conductive acrylonitrile-butadiene rubber.

U.S. Pat. No. 6,921,565 to Saupe et al. teaches a hose having an inner FKM rubber layer, a quad fluoropolymer barrier layer derived from (i) tetrafluoroethylene (ii) hexafluoropropylene (iii) vinylidene fluoride and (iv) a perfluorovinyl ether and a polymeric layer, which may be the same as the inner FKM layer next to the barrier. While such multilayer fuel hoses provide adequate impermeability characteristics, such hoses generally are not capable of exhibiting extended service life at the high operating temperatures. Accordingly, there is a need in the industry to provide hoses that are not only effective in reducing hydrocarbon emission into the atmosphere, but are also capable of effectively withstanding extremely high temperatures over long periods of time.

### SUMMARY OF THE INVENTION

A fuel resistant, fuel impermeable hose is provided wherein the fuel resistant, fuel impermeable hose surprisingly exhibits superior high temperature resistance compared to convention hoses. The hose of the present invention comprises: at least one fluoropolymer inner layer and a backing layer formed from one or more specific elastomeric materials selected from the group consisting of ethylene-acrylate elastomer (AEM), an ethyl-vinyl acetate copolymer (EVM), an acrylic rubber (ACM), and blends thereof. In certain application, it may be desirable or required to provide added physical strength to the hose. Where such physical strength is desired or required, the hose of the present invention may further comprise a reinforcement member around the backing layer and an outer cover formed from a material similar to that of the backing layer, around the reinforcement member

The multilayer fuel hose of the present invention not only exhibits superior improved service life under conditions of high temperature for extended periods of time, but also meets the requirements for reduced hydrocarbon fuel emissions. Furthermore, the present multilayer hose offers improved strength and durability compared to conventional hoses.

In a first embodiment, the hose of the present invention comprises a fluoroelastomer inner layer, a thermoplastic fluoropolymer barrier layer and a high temperature-resistant backing layer. Where a reinforced hose is desirable, the hose of the first embodiment further comprises an optional reinforcement member surrounding the backing layer and a high temperature-resistant outer cover layer over the reinforcement member

In a second embodiment, the hose of the present invention comprises a blend of a fluoroelastomer having fuel resistant properties and a thermoplastic fluoropolymer having fuel impermeability properties, and a high temperature-resistant backing layer over the outer surface of the blend of the fluoroelastomer and the thermoplastic fluoropolymer. Where a reinforced hose is desired, the hose of the second embodiment further comprises an optional reinforcement member surrounding the backing layer and a high temperature-resistant outer cover layer over the reinforcement member.

Since it is well known in the industry that hoses used to transport fuels contain a conductive agent or otherwise exhibit conductive characteristics in order to dissipate any electrical buildup that may occur during the flow of fuel through the hose, the hose of the present invention also may contain such conductive agent.

Typically, the hoses of the present invention are useful as an automobile fuel vent hose, fuel filler hose, vapor lines and fuel feed lines and are particularly useful in an environment producing high temperatures for extended periods of time.

### BRIEF DESCRIPTION OF THE DRAWINGS

FIG. 1 is a perspective view illustrating a first embodiment of the invention;

FIG. 2 is a perspective view illustrating an optional feature of the first embodiment of the invention;

FIG. 3 is a perspective view illustrating a second embodiment of the invention;

FIG. 4 is a perspective view illustrating an optional aspect of the second embodiment of the invention.

FIG. 5 is a perspective view illustrating a third embodiment of the invention;

FIG. 6 is a perspective view illustrating an optional feature of the third embodiment of the invention;

FIG. 7 is a perspective view illustrating a fourth embodiment of the invention; and

FIG. 8 is a perspective view illustrating an optional aspect of the fourth embodiment of the invention.

### DETAILED DESCRIPTION OF THE INVENTION

In accordance with the present invention, a fuel impermeable, fuel resistant hose having improved high temperature resistance sufficient to provide increased service life at high operating temperatures over extended time periods comprises at least one fluoropolymer tubular structure, and a backing layer of certain specified materials wherein the certain specified material unexpectedly exhibits sufficient high temperature resistance providing desirable extended service life over extended periods of time.

In accordance with the first embodiment of the invention, the high temperature resistant hose of the present invention comprises an inner tubular structure comprising a first fluoropolymer having fuel resistance, a barrier layer having fuel impermeability characteristics, and a backing layer of a high temperature-resistant material having sufficient thickness to provide desirable high temperature characteristics. The high temperature-resistant backing layer is constructed of ethylene-acrylic elastomer (AEM), ethylene-vinyl acetate (EVM), acrylic rubber (ACM), or blends thereof.

In accordance with the second embodiment of the invention, the high temperature resistant hose of the present invention comprises a blend of a first fluoroelastomer having fuel resistant characteristics, and a second thermoplastic fluoropolymer having fuel impermeability characteristics, and a backing layer exhibiting high temperature-resistant characteristics.

The hose of the first and second embodiments may further include a reinforcement member surrounding the backing layer and an outer high temperature resistant cover layer formed from materials similar to that of the backing layer, surrounding the reinforcement member.

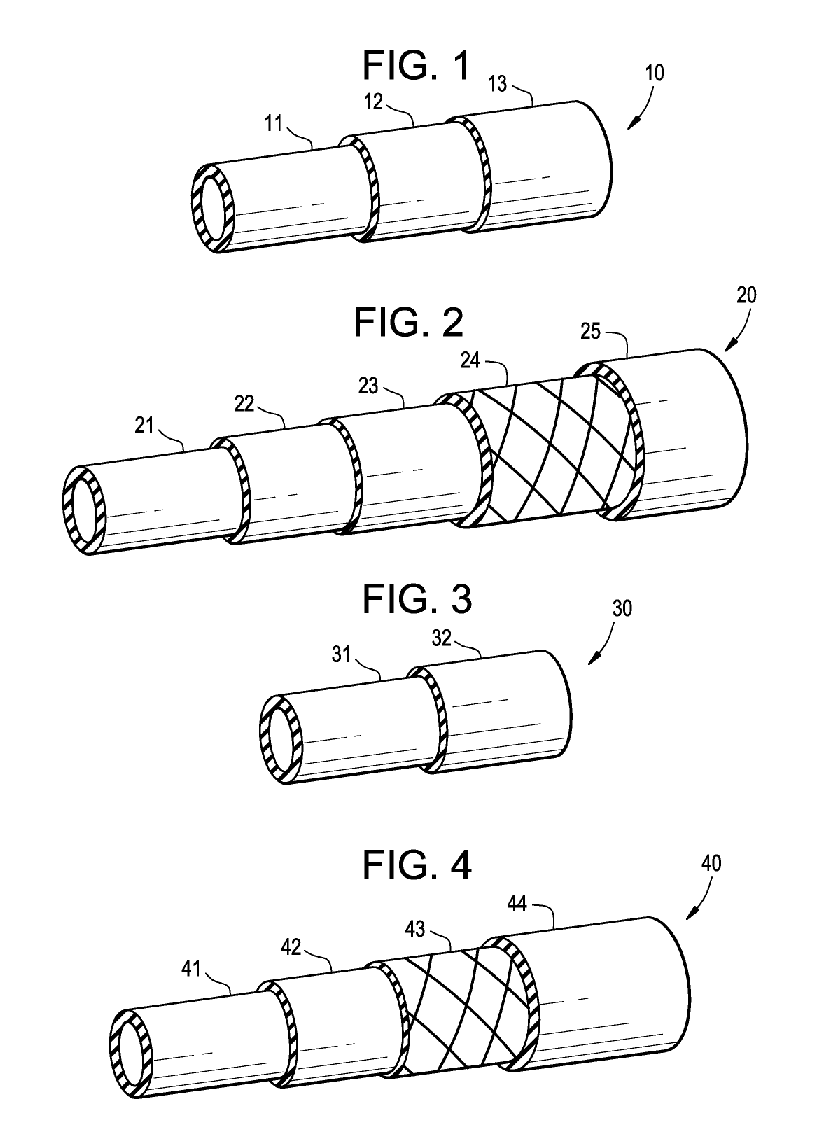

With respect to the drawings, FIG. 1 illustrates a tubular structure 10 made from a fluoroelastomer inner layer 11, a fluoroplastic barrier layer 12 surrounding the fluoroelastomer layer 11, and a high temperature-resistant backing layer 13 surrounding the fluoroplastic layer 12; the high temperature-resistant backing layer 13 forming the outside cover of the tubular structure 10.

FIG. 2 illustrates a tubular structure 20 made from a fluoroelastomer inner layer 21, a fluoroplastic barrier layer 22 surrounding the fluoroelastomer layer 21, a high temperature-resistant backing layer 23 surrounding the fluoroplastic layer 22, a reinforcement member 24 surrounding the high temperature-resistant backing layer 23, and a high temperature-resistant cover layer 25 surrounding the reinforcement member 24.

FIG. 3 illustrates a tubular structure 30 having an inner layer 31 made from a blend of a fluoroelastomer having fuel resistant properties and a thermoplastic fluoropolymer having fuel impermeability properties, and a high temperature-resistant backing layer 32 surrounding the inner layer 31; the high temperature-resistant backing layer 32 forming the outside cover of the tubular structure 30.

FIG. 4 illustrates a tubular structure 40 having an inner layer 41 made from a blend of a fluoroelastomer having fuel resistant properties and a thermoplastic fluoropolymer having fuel impermeability properties, a high temperature-resistant backing layer 42 surrounding the inner layer 41, a reinforcement member 43 surrounding the high temperature-resistant backing layer 42, and a high temperature-resistant cover layer 44 surrounding the reinforcement layer 43.

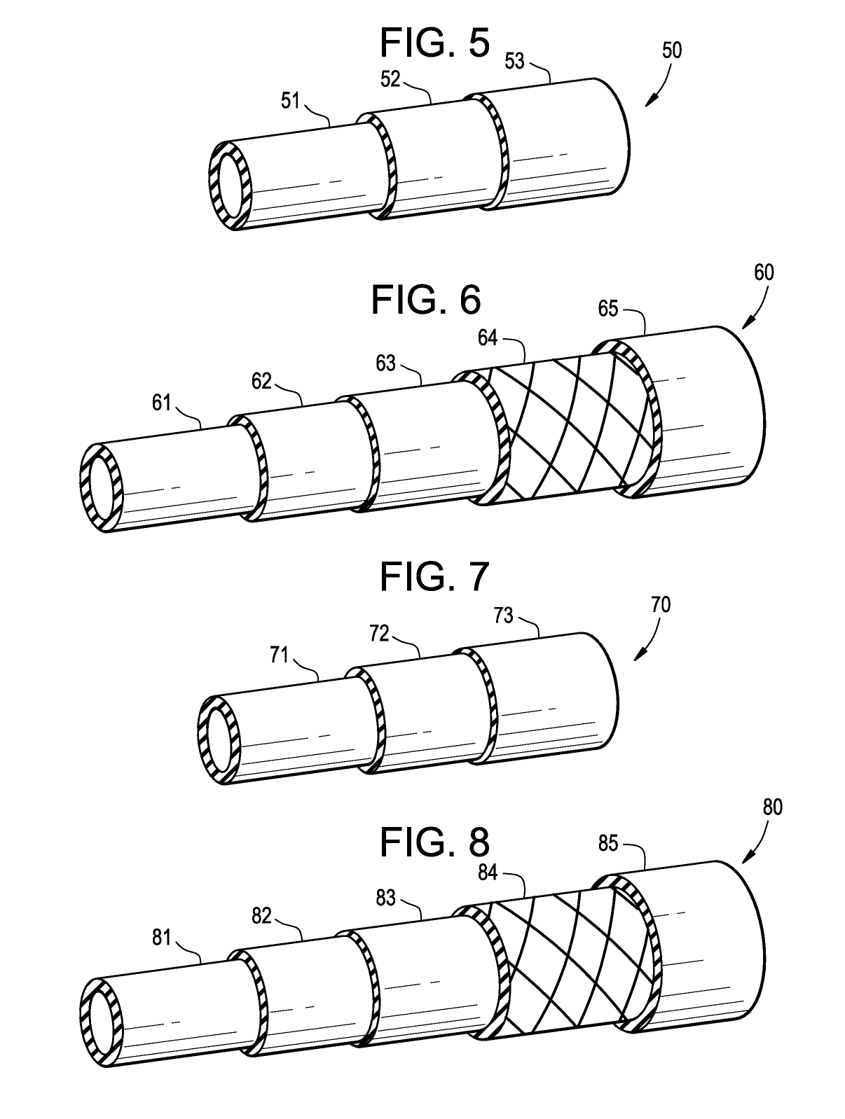

FIG. 5 illustrates a tubular structure 50 made from a fluoroelastomer inner layer 51, a thermoplastic quadpolymer barrier layer 52, surrounding the fluoroelastomer layer 51, and a high temperature-resistant backing layer 53 surrounding the thermoplastic quadpolymer barrier layer 52; the high temperature-resistant backing layer 53 forming the outside cover of the tubular structure 50.

FIG. 6 illustrates a tubular structure 60 made from a fluoroelastomer inner layer 61, a thermoplastic quadpolymer barrier layer 62 surrounding the fluoroelastomer layer 61, a high temperature-resistant backing layer 63 surrounding the thermoplastic quadpolymer barrier layer 62, a reinforcement member 64 surrounding the high temperature-resistant backing layer 63, and a high temperature-resistant cover layer 65 surrounding the reinforcement member 64.

FIG. 7 illustrates a tubular structure 70 having an inner layer 71 made from a blend of a fluoroelastomer having fuel resistant properties and a thermoplastic fluoropolymer having fuel impermeability properties, a fluoroplastic barrier layer 72 surrounding the inner layer 71, and a high temperature-resistant backing layer 73 surrounding the fluoroplastic barrier layer 72; the high temperature-resistant backing layer 73 forming the outside cover of the tubular structure 70.

FIG. 8 illustrates a tubular structure 80 having an inner layer 81 made from a blend of a fluoroelastomer having fuel resistant properties and a thermoplastic fluoropolymer having fuel impermeability properties, a fluoroplastic barrier layer 82 surrounding the inner layer 81, a high temperature-resistant backing layer 83 surrounding the fluoroplastic barrier layer 82, a reinforcement member 83 surrounding the high temperature-resistant backing layer 82, and a high temperature-resistant cover layer 84 surrounding the reinforcement layer 83.

In accordance with the first embodiment of the invention, the inner layer of the tubular structure comprises at least two layers of polymeric materials. The first layer of polymeric material comprises a first inner polymer having excellent resistance to all types of hydrocarbon fuels and oils. The second layer comprises a second polymer layer surrounding the first polymer layer wherein the second polymer layer has excellent hydrocarbon fuel impermeability properties. Typically, the polymeric material employed as the first inner layer is a fluoroelastomer such as an FKM fluoroelastomer, e.g., hexafluoropropylene-vinylidene fluoride copolymer, elastomeric vinylidene fluoride-hexafluoropropylene-tetrafluoroethylene terpolymer; and the like. However, certain other elastomeric polymers may be employed as the inner layer providing that the elastomeric polymer exhibits the desired fuel resistance. Examples of such certain other polymeric materials include, styrene-butadiene rubber (SBR); butadiene-nitrile rubber such as butadiene-acrylonitrile rubber, chlorinated polyethylene, chlorosulfonated polyethylene, vinylethylene-acrylic rubber, acrylic rubber, epichlorohydrin, e.g., Hydrin 200, a copolymer of epichlorohydrin and ethylene oxide available from DuPont, polychloroprene rubber (CR), polyvinyl chloride, ethylene-propylene copolymers (EPM), ethylene-propylene-diene terpolymer (EPDM), ultra high molecular weight polyethylene (UHMWPE), high density polyethylene (HDPE), and blends thereof. Most preferably, the inner layer is an FKM fluoroelastomer composition such as fluoroelastomeric tetrafluoroethylene-hexafluoropropylene-vinylidene terpolymers. Fluoroelastomers, which have been found to be useful in the present invention, are the FLUOREL fluoroelastomers available from 3M.

The polymeric material forming the second layer is any polymeric material exhibiting sufficient fuel impermeability to meet automotive standards. Typically, such polymeric materials are thermoplastic fluoropolymers such as tetrafluoroethylene-hexafluoropropylene-vinylidene fluoride terpolymers(THV); a fluoroquad polymer derived, e.g., from (i) tetrafluoroethylene (ii) hexafluoropropylene (iii) vinylidene fluoride and (iv) a perfluorovinyl ether; and the like

In accordance with the second embodiment of the invention, the inner layer is a barrier layer comprising a blend of two or more fluoropolymers wherein at least one of the fluoropolymers is characterized as having elastomeric characteristics and at least one of the fluoropolymers is characterized as having fluoroplastic characteristics. Since the permeability of the fuel hose to fuel vapors decreases with an increase in the fluorine content of the blend, a higher ratio of the thermoplastic fluoropolymer component which typically contains a higher percentage of fluorine by weight than the fluoroelastomer component may be employed in the blend; however, the plastic-like properties of the thermoplastic fluoropolymer components are prone to cause kinking of the hose when the thermoplastic fluoropolymer component is too high. Typically, the fluorine content of the fluoroelastomer component of the blend is about 68 to 74% and the fluorine content of the thermoplastic fluoropolymer component of the blend is about 73 to 78%. Such blends have been found to provide a good balance between reduced fuel vapor permeability, good fuel resistance, and good physical properties of the hose. Typically, the thickness of the barrier layer is about 5 to 25 mils, preferably about 10 to 20 mils and most preferably about 13 to 15 mils.

Typically, the barrier layer is a blend of a fluoroelastomeric hexafluoropropylene-vinylidene fluoride copolymer or a fluoroelastomeric vinylidene fluoride-hexafluoropropylene-tetrafluoroethylene terpolymer, and a thermoplastic tetrafluoroethylene-hexafluoropropylene-vinylidene fluoride terpolymer. The barrier layer may contain about 95 to 5 weight percent of the fluoroelastomer component and about 5 to 95 weight percent of the thermoplastic fluoropolymer component. Preferably, the blend will contain about 80 to 20 weight percent of the fluoroelastomeric component and about 20 to 80 weight percent of the thermoplastic fluoropolymer Most preferably, the blend forming the barrier layer of the hose will contain about 20 to 50 weight percent of the fluoroelastomer and about 50 to 20 weight percent of the thermoplastic fluoropolymer. The hexafluoropropylene-vinylidene fluoride fluoroelastomer is commercially available from DuPont under the name Viton A, Viton E445 or Viton 60. The vinylidene fluoride-hexafluoropropylene-tetrafluoroethylene fluoroelastomer is commercially available from 3M under the name Fluorel FT2350 or FE58300QD. The tetrafluoroethylene-hexafluoropropylene-vinylidene fluoride fluoroplastic terpolymer is commercially available as Dyneon THV from Dyneon. In accordance with the second embodiment of the invention, it is not particularly required that the hose comprise a first inner layer of an elastomer; However, certain elastomeric polymers may be employed as the inner layer providing that the elastomeric polymer exhibits the desired fuel resistance. Examples of such certain other polymeric materials include, fluoroelastomers, styrene-butadiene rubber (SBR); butadiene-nitrile rubber such as butadiene-acrylonitrile rubber, chlorinated polyethylene, chlorosulfonated polyethylene, vinylethylene-acrylic rubber, acrylic rubber, epichlorohydrin, e.g., Hydrin 200, a copolymer of epichlorohydrin and ethylene oxide available from DuPont, polychloroprene rubber (CR), polyvinyl chloride, ethylene-propylene copolymers (EPM), ethylene-propylene-diene terpolymer (EPDM), ultra high molecular weight polyethylene (UHMWPE), high density polyethylene (HDPE), and blends thereof

Typically, the backing layer of conventional tubular structures is a nitrile such as acrylonitrile-butadiene polymer, or an epichlorohydrin (ECO) material. It has now been found that, in the manufacture of a fuel hose, a backing layer made from a material selected from the group consisting of ethylene-acrylate elastomer (AEM), ethyl-vinyl acetate copolymer (EVM), acrylic rubber (ACM), and blends thereof, provides a hose having not only resistance to fuel permeation, but the hose also exhibits superior high temperature-resistance compared to conventional fuel hoses. Preferably, the outer cover layer is formed from an ethylene-acrylate elastomer such as an ethylene-methacrylate elastomer or a blend of ethylene-acrylate elastomers containing at least one ethylene-methacrylate elastomer. Ethylene-methacrylate elastomers are available from E. I DuPont under the name Vamac.

The multilayer hoses of the present invention are either unvulcanized or vulcanized using any of the art established vulcanizing agents such as peroxides, polyols, polyamines, etc. The peroxide vulcanizing agent includes, for example, dicumyl peroxide, 2-5-dimethyl-2,5-di(t-butylperoxy)hexyne-3, etc. The polyol vulcanizing agent includes, e.g., hexafluoroisopropylidene-bis(4-hydroxyphenyl-hydroquinone, isopropylidene-bis(4-hydroxyphenyl), and the like. The polyamine vulcanizing agent includes, e.g., hexamethylenediamine carbamate, alicyclic diamine carbamate, etc. The amount of vulcanizing agents employed is generally that which is customarily used in the art. Typically, about 0.5 to 10% vulcanizing agent is employed depending upon the vulcanizing agent employed.

The optional reinforcement materials useful in the present invention are materials that afford physical strength to the finished hose. Typically, the reinforcement member is a plurality of synthetic or natural fibers selected from the group consisting of glass fibers, cotton fibers, polyamide fibers, polyester fibers, rayon fibers and the like. Preferably, the reinforcement material is an aromatic polyamide such as Kevlar or Nomex, both of which are manufactured by DuPont. The reinforcing materials may be knitted, braided or spiraled to form the reinforcement member. In a preferred aspect of the invention, the reinforcing material is spiraled. While the reinforcement member may be a preferred component of the present hose structure, it is not critical in every application. Therefore, the reinforcement member may or may not be used in the manufacture of certain hoses depending on the requirements of the manufacturer.

The outer cover is similar to the backing layer and is made from a material selected from the group consisting of ethylene-acrylate elastomer (AEM), ethyl-vinyl acetate copolymer (EVM), acrylic rubber (ACM), and blends thereof to provide a hose having not only resistance to fuel permeation, but also superior high temperature-resistance compared to conventional fuel hoses. Preferably, the outer cover layer is formed from an ethylene-acrylate elastomer such as an ethylene-methacrylate elastomer or a blend of ethylene-acrylate elastomers containing at least one ethylene-methacrylate elastomer.

As is common practice in the industry, the inner most layer of the multilayer hose contains a conductive material such as metal or carbon. Preferably, the conductive material is carbon in the form of carbon black, but may be any conductive agent or combination of conducting agents commonly recognized in the industry to provide conductivity to a rubber or plastic material. Examples of such conductive agents include elemental carbon in the form of carbon black and carbon fibrils, metals such as copper, silver, gold, nickel, and alloys or mixtures of such metals. The use of such conductive agents is known in the art to dissipate static electricity in the transportation of a fluid through the tubular structure. Non-conducting elastomeric polymer materials may be employed as the inner layer in applications where dissipation of static electricity is not required.

Other conventional additives such as antioxidants, surfactants, accelerators, mineral fillers, plasticizers, metal oxides/hydroxides, processing aids, lubricants, surfactants, curing agents or crosslinking agents, co-agents, etc. may be employed in the backing layer or the outer cover layer of the present constructions in appropriate amounts and methods known in the art to provide their desired effects.

The hose of the present invention may further contain a reinforcement member and/or an outer cover material constructed from the preferred heat-resistant backing material layer of the present invention, e.g., ethylene-acrylic elastomer (ACM), ethyl-vinyl acetate (EVM) and acrylic rubber (AEM). Preferably, the backing layer and the outer cover layer are both made from an ethylene-acrylic elastomer (AEM), an ethyl-vinyl acetate copolymer (EVM), an acrylic rubber (AEM), and blends thereof.

The tubular structures of the present invention are formed by known methods such as extruding the various layers using simultaneous, extrusion, tandum extrusion, or coextrusion. Typically, the hose of the present invention are produced by separate or tandum extrusion for versatility and economic reasons.

Having described the invention in detail and by reference to preferred embodiments thereof, it will be apparent to those skilled in the art that modifications and variations are possible without departing from the scope of the invention as defined in the appended claims.

What is claimed is:

1. A fuel impermeable, fuel resistant hose having improved high temperature resistant: characteristics sufficient to provide extended service life of said hose in a harsh thermal environment, said hose comprising:
at least one fluoropolymer tubular structure, and
a backing layer surrounding said at least one fluoropolymer tubular structure wherein said
backing layer comprises at least one high temperature resistant elastomer selected from the group consisting of ethylene-acrylate elastomer, ethyl-vinyl acetate copolymer, acrylic rubber, and blends thereof.

2. The hose of claim 1 wherein said at least one fluoropolymer tubular structure comprises:
a first fluoropolymer layer wherein said first fluoropolymer layer is a fluoroelastomer exhibiting fuel resistant characteristics; and
a second fluoropolymer layer surrounding said first fluoropolymer wherein said second fluoropolymer layer is a thermoplastic fluoropolymer barrier layer exhibiting fuel impermeable characteristics.

3. The hose of claim 2 wherein said first fluoropolymer is an FKM fluoroelastomer selected from the group consisting of hexafluoropropylene-vinylidene copolymer and a vinylidene fluoride-hexafluoropropylene-tetrafluoroethylene terpolymer.

4. The hose of claim 2 wherein said second fluoropolymer is a thermoplastic fluoropolymer selected from the group consisting of a tetrafluoroethylene-hexafluoropropylene-vinylidene fluoride terpolymer and a fluoroquad polymer derived from (i) tetrafluoroethylene (ii) hexafluoropropylene (iii) vinylidene fluoride and (iv) a perfluorovinyl ether.

5. The hose of claim 1 wherein said at least one fluoropolymer tubular structure comprises a blend of a first fluorointerpolymer exhibiting elastomeric characteristics and a second fluorointerpolymer exhibiting thermoplastic characteristics.

6. The hose of claim 5 wherein said blend of said first fluorointerpolymer and said second fluorointerpolymer comprises about 5 to 95 weight percent of said first fluorointerpolymer having a fluorine content of about 65 to 74 weight percent with about 95 to 6 weight percent of said second fluorointerpolymer having a fluorine content of about 70 to 78 weight percent, wherein said first fluorointerpolymer is a copolymer or terpolymer formed by the copolymerization of two or more monomers selected from the group consisting of tetrafluoroethylene, hexafluoropropylene and vinylidene fluoride, and said second fluoropolymer is a terpolymer formed by the copolymerization of tetrafluoroethylene, hexafluoropropylene, and vinylidene fluoride.

7. The hose of claim 5 wherein said blend of said first fluorointerpolymer and said second fluorointerpolymer comprises about 20 to 80 weight percent of said first fluorointerpolymer having a fluorine content of about 65 to 73 weight percent with about 80 to 20 weight percent of said second fluorointerpolymer having a fluorine content of about 70 to 75 weight percent, wherein said first fluorointerpolymer is a copolymer or terpolymer formed by the copolymerization of two or more monomers selected from the group consisting of tetrafluoroethylene, hexafluoropropylene and vinylidene fluoride, and said second fluoropolymer is a terpolymer formed by the copolymerization of tetrafluoroethylene, hexafluoropropylene, and vinylidene fluoride.

8. The hose of claim 5 wherein said at least one fluoropolymer further comprises a thermoplastic tetrafluoroethylene-hexafluropropylene-vinylidene fluoride terpolymer layer surrounding said blend of said first fluorointerpolymer and said second fluoronterpolymer.

9. The hose of claim 1 wherein said at least one backing layer further comprises at least one additive selected from the group consisting of one or more plasticizers, one or more antioxidants, one or more process aids, one or more fillers, one or more accelerators, and one or more curatives wherein said combination of additives is sufficient to provide their desired effects.

10. The hose of claim 1 wherein said at least one high temperature resistant elastomer is a blend of two or more ethylene-acrylate elastomers.

11. The hose of claim 10 wherein said blend of two or more ethylene-acrylate elastomers comprises at least one ethylene-methacrylate elastomer.

12. The hose of claim 1 further comprising: a reinforcement member surrounding said backing layer.

13. The hose of claim 12 wherein said reinforcement member is a synthetic or natural fiber selected from the group glass fibers, cotton fibers, rayon fibers, polyester fibers, polyamide fibers, and polyamide fibers.

14. The hose of claim 12 further comprising a high temperature-resistant outer cover layer surrounding said reinforcement layer wherein said high temperature-resistant outer cover layer comprises at least one elastomer selected from the group consisting of ethylene-acrylate elastomer, ethyl-vinyl acetate copolymer, acrylic rubber, and blends thereof, said outer cover layer exhibiting improved high temperature resistance compared to conventional cover layers.

15. The hose of claim 14 wherein said high temperature-resistant outer cover layer further comprises a combination of additives selected from the group consisting of one or more plasticizers, one or more antioxidants, one or more process aids, one or more fillers, one or more accelerators, and one or more curatives.

16. The hose of claim 14 wherein said at least one elastomer is a blend of two or more ethylene-acrylate elastomers.

17. The hose of claim 16 wherein said blend of two or more high temperature-resistant ethylene-acrylate elastomers comprises at least one ethylene-methacrylate copolymer.

18. The hose of claim 1 wherein said at least one fluoropolymer tubular structure contains a conductive material selected from the group consisting of carbon, copper, silver, gold, nickel, and mixtures or alloys thereof.

19. A high temperature-resistant hose having fuel impermeable and fuel resistant properties, said hose comprising:
a conductive FKM fluoroelastomer inner layer selected from the group consisting of hexafluoropropylene-vinylidene copolymer or a vinylidene fluoride-hexafluoropropylene-tetrafluoroethylene terpolymer wherein said conductive FKM fluoroelastomer exhibits resistance to hydrocarbon fuels and oils;
a barrier layer selected from the group consisting of a thermoplastic tetrafluoroethylene-hexafluoropropylene-vinylidene terpolymer, and a thermoplastic quadpolymer derived from (i) tetrafluoroethylene (ii) hexafluoropropylene (iii) vinylidene fluoride and (iv) a perfluorovinyl ether wherein said barrier surrounds said conductive FKM fluoropolymer wherein said barrier layer exhibits hydrocarbon fuel permeation resistance; and
a high temperature-resistant backing layer having an inner surface and an outer surface, said inner surface of said high temperature-resistant backing layer surrounding said outer surface of said thermoplastic tetrafluoroethylene-hexafluoropropylene-vinylidene terpolymer wherein said high temperature backing layer comprises at least one high temperature elastomer selected from the group consisting of ethylene-acrylate elastomer, ethylene-vinyl acetate copolymer, acrylic rubber, and blends thereof.

20. The hose of claim 19 further comprising;
a reinforcement member adjacent said high temperature-resistant backing layer, wherein said reinforcement member is a synthetic or natural fiber selected from the group glass fibers, cotton fibers, rayon fibers, polyester fibers, polyamide fibers, and polyamide fibers; and
a high temperature-resistant outer cover adjacent said reinforcement member, wherein said high temperature outer cover layer is selected from the group consisting of ethylene-acrylate elastomer, ethylene-vinyl acetate copolymer, acrylic rubber, and blends thereof.

21. A high temperature-resistant hose having fuel impermeable and fuel resistant properties, said hose comprising:
a conductive blend of about 5 to 95 weight percent of a first fluorointerpolymer having a fluorine content of about 65 to 74 weight percent with about 95 to 5 weight percent of a second fluorointerpolymer having a fluorine content of about 70 to 78 weight percent, wherein said first fluorointerpolymer is a copolymer or terpolymer formed by the copolymerization of two or more monomers selected from the group consisting of tetrafluoroethylene, hexafluoropropylene and vinylidene fluoride, and said second fluoropolymer is a terpolymer formed by the copolymerization of tetrafluoroethylene, hexafluoropropylene, and vinylidene fluoride, wherein said first fluorointerpolymer exhibits elastomeric characteristics and said second fluorointerpolymer exhibits thermoplastic characteristics; a fluoroquad polymer derived from (i) tetrafluoroethylene (ii)hexafluoropropylene (iii) vinylidene fluoride and (iv) a perfluorovinyl ether; and
a high temperature-resistant backing layer surrounding said conductive thermoplastic inner layer, wherein said high temperature-resistant backing layer comprises a high temperature resistant elastomer selected from the group consisting of ethylene-acrylate elastomer, ethylene-vinyl acetate copolymer, acrylic rubber, and blends thereof.

22. The hose of claim 21 further comprising;
a reinforcement member adjacent said high temperature-resistant backing layer, wherein said reinforcement member is a synthetic or natural fiber selected from the group glass fibers, cotton fibers, rayon fibers, polyester fibers, polyamide fibers, and polyamide fibers; and
a high temperature-resistant outer cover adjacent said reinforcement member, wherein said high temperature outer cover layer is selected from the group consisting of ethylene-acrylate elastomer, ethylene-vinyl acetate copolymer, acrylic rubber, and blends thereof.
